(19) United States
(12) Patent Application Publication
(10) Pub. No.: US 2010/0104869 A1
(43) Pub. Date: Apr. 29, 2010

(54) Photonic Crystal Fibers and Methods for Manufacturing the Same

(75) Inventors: Nicholas Francis Borrelli, Elmira, NY (US); Karl William Koch, III, Elmira, NY (US); David John Mcenroe, Corning, NY (US)

Correspondence Address: CORNING INCORPORATED, SP-TI-3-1, CORNING, NY, 14831, US

(73) Assignee: Corning Incorporated, Corning, NY (US)

(21) Appl. No.: 12/528,741

(22) PCT Filed: Feb. 20, 2008
(86) PCT No.: PCT/US08/02243

§ 371 Date: Dec. 16, 2009

Related U.S. Application Data
(60) Provisional application No. 60/903,901, filed on Feb. 28, 2007.

(51) Int. Cl. D02G 3/36; C03B 37/075; D02G 3/18

(52) U.S. Cl. 428/392; 65/437; 428/400

(57) ABSTRACT

Photonic crystal fibers include a plurality of extruded non-circular canes, each of the extruded non-circular canes comprising at least one hole. Methods for manufacturing photonic crystal fibers include hot-forming a glass material into a glass tube having a non-circular outer cross-section, drawing the glass tube to obtain a plurality of canes, stacking the canes to create a preform build and drawing the preform build to obtain a photonic crystal fiber.

### CROSS-REFERENCE TO RELATED APPLICATIONS

This application claims the benefit of U.S. Provisional Patent Application No. 60/903,901 filed on Feb. 28, 2007 entitled “PHOTONIC CRYSTAL FIBERS AND METHODS FOR MANUFACTURING THE SAME,” the content of which is relied upon and incorporated herein by reference in its entirety.

### BACKGROUND

1. Field of the Invention

This invention relates to photonic crystal fibers and methods for manufacturing the same.

2. Technical Background

Conventional optical waveguide fibers represent a balance between optical losses, non-linearity, group velocity, dispersion and polarization effects. However, photonic crystal fibers (including photonic bandgap fibers and others) have recently garnished widespread interest for their efficient way of enhancing nonlinear optical interaction between pulses of light and their bulk constituents. Photonic crystal fibers find application in fiber-optic communications, fiber lasers, nonlinear devices, high-power transmission, highly sensitive gas sensors, and other areas.

Current fabrication processes for photonic crystal fibers include a stack-and-draw technique for creating a microstructure array. Particularly, in the stack-and-draw process, numerous glass capillaries are arranged in a lattice array inside an outer support tube in order to create the desirable macroscopic cross-sectional geometries. The array is then drawn and built into a fiber. The stack-and-draw process has issues in that it is a relatively slow process done by hand, and is not consistent from one preform build to another. In addition, because of the inconsistencies of the process, the circular shaped capillaries often become misaligned during fusion and/or draw resulting in voids or defects in the fiber. Such unintentional defects dramatically increase the optical losses in photonic crystal fibers.

In addition to problems with consistency and defects, it is very difficult to change the geometry of a capillary or a preform build with conventional processes. For example, while a majority of photonic crystal fibers are drawn from fiber preforms with a circular geometry, studies have recently been conducted on hexagonal geometries. Conventional processes for fabrication of hexagonal preforms have included preparing a tube by CVD and then grinding the outer diameter of the tube to create a hexagonal geometry. The ground hexagonal tube can be redrawn to capillaries and each capillary is then stacked into a macroscopic array and drawn down under vacuum. Difficulties arise not only in the time and expense required to manufacture these hexagonal tubes and assemble the preform build, but also when the capillaries twist and move during the build process, creating unintentional voids in the fiber. Again, unintentional voids or defects increase optical losses.

Accordingly, there is a need for high quality photonic crystal fibers having unique geometries that can be repeatably manufactured with fewer defects.

### SUMMARY

The invention is intended to address and obviate problems and shortcomings and otherwise improve previous photonic crystal fibers and methods of manufacturing the same.

To achieve the foregoing, one embodiment of the invention includes a method for manufacturing a photonic crystal fiber including hot-forming a glass material into a glass tube having a non-circular outer cross-section, drawing the glass tube to obtain a plurality of canes, stacking the canes to create a preform build and drawing the preform build to obtain a photonic crystal fiber.

To further achieve the foregoing, one embodiment of the invention includes A method for manufacturing a photonic crystal fiber including extruding a precursor glass material having a composition, expressed in terms of weight percentages on an oxide basis, comprising: 55%-75% SiO₂, 5%-10% Na₂O, 20%-35% B₂O₃ and 0%-5% Al₂O₃, to obtain a glass tube having a plurality of channels extending along the axis of the tube, leaching the glass tube to obtain a porous glass tube comprising at least 90% by weight of silica, heating the porous glass tube such that the pores in the glass structure collapse to form densified glass to obtain a densified glass tube, drawing the densified glass tube to obtain a plurality of glass canes, forming a stack of the glass canes, each of the glass canes in direct contact with an adjacent glass cane in the stack and drawing the stack to obtain a photonic crystal fiber.

To further achieve the foregoing, one embodiment of the invention includes a photonic crystal fiber preform build comprising a plurality of extruded non-circular glass canes, each of the extruded non-circular glass canes comprising at least one channel extending along the axis of the cane.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is an image of a bottom view of an exemplary die for manufacturing an exemplary tube for use in a photonic crystal fiber in accordance with the present invention;

FIGS. 2A-2C are a schematic illustrations of an exemplary process for manufacturing a photonic crystal fiber in accordance with the present invention;

FIGS. 3A-3C are images of an alternative exemplary tube manufactured in accordance with exemplary embodiments of the present invention;

FIGS. 4A-4B are schematic illustrations of alternative exemplary processes for manufacturing a photonic crystal fiber in accordance with the present invention; and

FIGS. 5A-5C are schematic illustrations of an alternative exemplary process for manufacturing a photonic crystal fiber in accordance with the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION

Unless otherwise indicated, all numbers such as those expressing weight percents of ingredients, dimensions, and values for certain physical properties used in the specification and claims are to be understood as being modified in all instances by the term “about.” It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, in describing and claiming the present invention, the use of the indefinite article “a” or “an” means “at least one,” and should not be limited to “only one” unless explicitly indicated to the contrary. Thus, for example, reference to “a cane” includes embodiments having two or more such canes, unless the context clearly indicates otherwise. As used herein, a “wt %” or “weight percent” or “percent by weight” of a component, unless specifically stated to the contrary, is based on the total weight of the composition or article in which the component is included. As used herein, all percentages are by weight unless indicated otherwise.

As described more fully herein, the inventors have developed a process to hot-form or extrude a multi-hole glass tube with a non-circular outer cross-section. The formed non-circular tube can be drawn down into smaller diameter tubes and stacked together to make a preform build. The outer diameter of each tube can have a geometric shape corresponding to the geometric shape of other tubes for consistent alignment and stacking of the tubes into a preform build array. The resulting product can be drawn into a cane (if desired) and jacketed with an outer tube to be drawn into photonic crystal fiber. The photonic crystal fibers manufactured with the processes described herein have unique geometric and transmittance characteristics as compared with conventional photonic crystal fibers.

It will be understood that the term “photonic crystal fiber” as used herein includes photonic crystal fibers, photonic-bandgap fibers (PCFs that confine light by bandgap effects), holey fibers (PCFs using air holes in their cross-sections), hole-assisted fibers (PCFs guiding light by a conventional higher-index core modified by the presence of air holes), and/or Bragg fibers (photonic bandgap fiber formed by concentric rings of multilayer dielectric or metal films).

In one embodiment, the glass material used in the processes of the present invention may be one selected from a group of glasses high in silica content. It is believed that the properties typically associated with such glasses are desired in geometrically complex structures. For example, glass precursors high in silica content usually have a softening temperature around 1500° C. or higher, have low thermal expansion and high UV transparency. In one embodiment, the glass precursor/materials may comprise the precursor to the VYCOR® product, manufactured by Corning Inc. of Corning, N.Y. Generally, VYCOR® starts as an alkali borosilicate glass that is put through processing steps to transform the alkali borosilicate glass into an at least 90% (e.g., about 95-96%) silica structure. This about 95-96% silica structure can be a porous body or a consolidated glass body.

The VYCOR® product and its glass precursor are described in Corning Inc.'s U.S. Pat. No. 2,106,744 (the '744 patent), which is hereby incorporated by reference in its entirety. As disclosed therein, glass compositions in a certain region of the ternary system —R₂O—B₂O₃—SiO₂— will, on the proper heat treatment, separate into two phases. One of the phases is very rich in silica, whereas the other phase is very rich in alkali and boric oxide. The '744 patent discloses a precursor composition of 75% SiO₂, 5% Na₂O, and 20% B₂O₃. However, other precursor compositions for use with the methods described herein include, for example, a composition of 60.82% SiO₂, 7.5% Na₂O, 28.7% B₂O₃, 2.83% Al₂O₃ and 0.15% Cl, such a composition having a softening point around 670° C. and thermal expansion of around 52.5×10⁻⁷/K. Of course, it should be understood that any other silica glass composition having a composition range (in weight percentage) of around 55-75% SiO₂, 5-10% Na₂O, 20-35% B₂O₃, 0-5% Al₂O₃ and 0-0.5% Cl are contemplated for use with the methods of the present invention.

While it is believed that high silica glasses such as those described herein and/or glasses with relatively low softening temperatures (e.g., soft glasses) are ideal for use with processes of the present invention, it should be understood that the invention is not so limited, and that a variety of glasses can be used to obtain high quality photonic crystal fibers described herein.

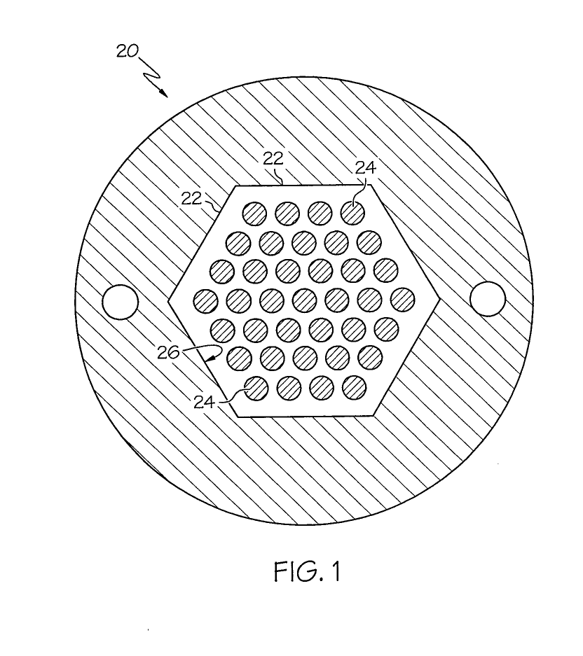

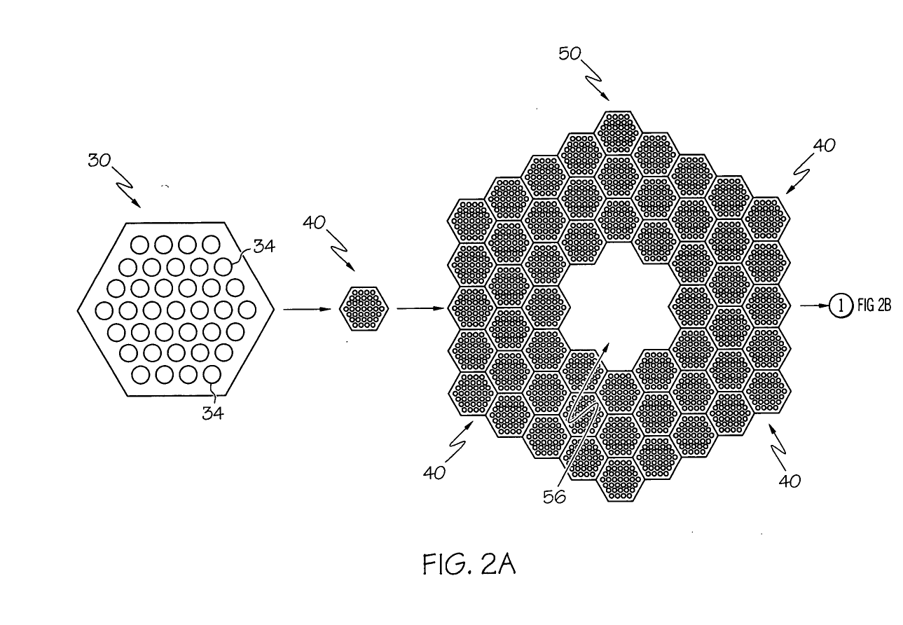

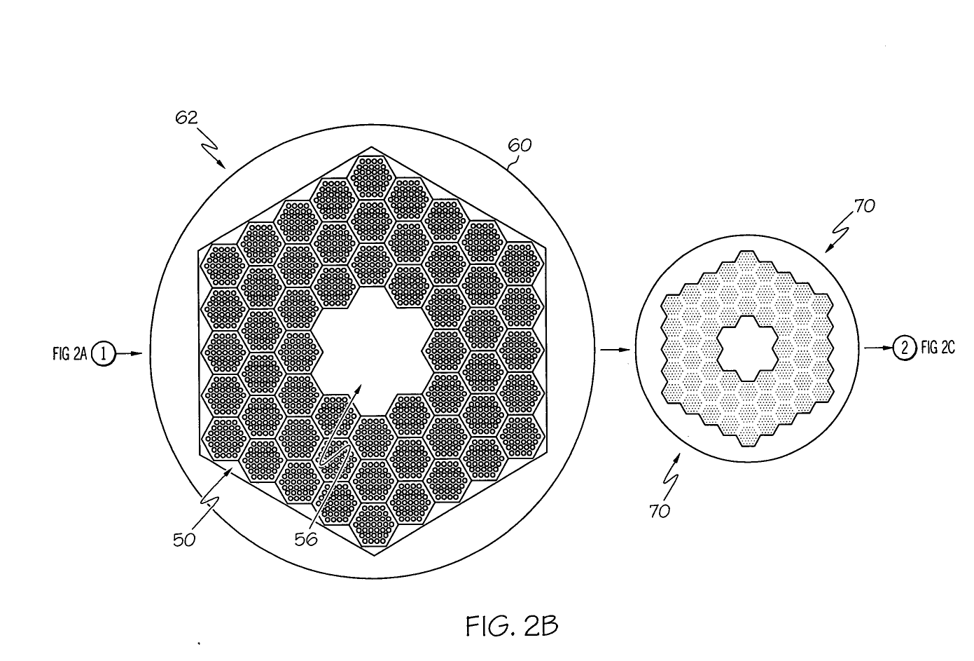

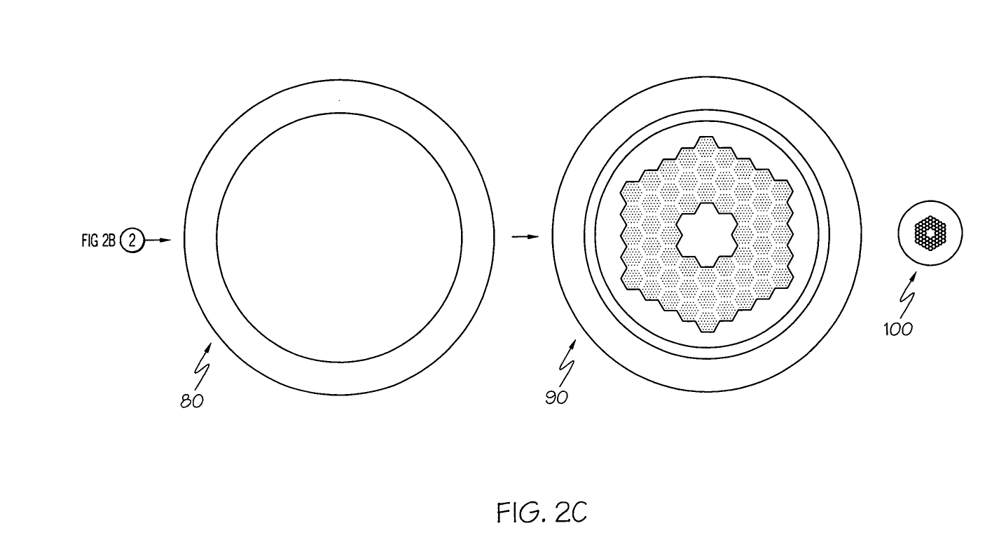

The exemplary process steps for fabricating photonic crystal fibers are schematically illustrated in FIGS. 1 and 2A-2C. In one embodiment, a die 20 (bottom view shown in FIG. 1) may comprise a hexagonal shape (e.g., the perimeter of the die has six sides 22) and include a thirty-seven pin 24 array. The hexagonal outer perimeter (e.g., outer diameter of the forming shape 26) is one example of a non-circular die configured to produce non-circular tubes. However, it should be understood that the die 20 can have any non-circular outer perimeter forming shape. As used herein, “non-circular” can include a triangle, a square, a pentagon, a polygon, a parallelogram or a trapezoid, or any asymmetrical shape, to name a few. As discussed later herein, the ability to hot-form or extrude tubes in a desired shape allows these tubes to be stacked in a way that improves manufacturing efficiency and enhances the characteristics of the resulting fibers, while minimizing defects.

The die 20 of FIG. 1 is illustrated as having thirty-seven pins 24. It is believed that thirty-seven is the most efficient number to produce the corresponding number of channels (e.g. 34 in FIG. 2A) in terms of utilization of space for a hexagonal structure. In another embodiment, however, a hexagonal die could have one, seven, nineteen, thirty-seven, fifty-five, seventy-nine, etc., pins (any number considering the hexagonal symmetry) to produce the corresponding number of channels 34 along an axis of the tube 30. As illustrated, the spatial periodicity (e.g., nearest channel distance is identical and all the channels have essentially the same number of neighboring channels except for those on the periphery) of the channels within tube 30 and the plurality of canes 40 is essentially the same. Moreover, the spatial periodicity in the stack 50 is essentially the same as in individual canes.

The number of pins for other non-circular dies may vary by application and the symmetry of the desired outer perimeter of the tube. However, it is believed that more channels in the produced tube 30 results in lower tunneling losses. In addition, where short wavelength applications are desired, the number of channels may increase to account for smaller pitch requirements. In addition, while the pins 24 of the die 20 of FIG. 1 are illustrated as being circular in shape (as are channels 34 of resulting tube 30), it should be understood that similar to the overall shape of the inner die 20, the shape of the pins 24 (and resulting channels 34) can comprise any shape including a triangle, a square, a pentagon, a polygon, a parallelogram or a trapezoid, to name a few. In addition, not all of pins/channels need to be the same size as the other pins/holes, such as when intentional defects are desired, as described later herein. For example, as illustrated in FIG. 1, the pins 24 at each point of the hexagon can be larger than the surrounding pins (e.g., to improve geometry of the extruded channels that otherwise distort on the outer corners during extrusion).

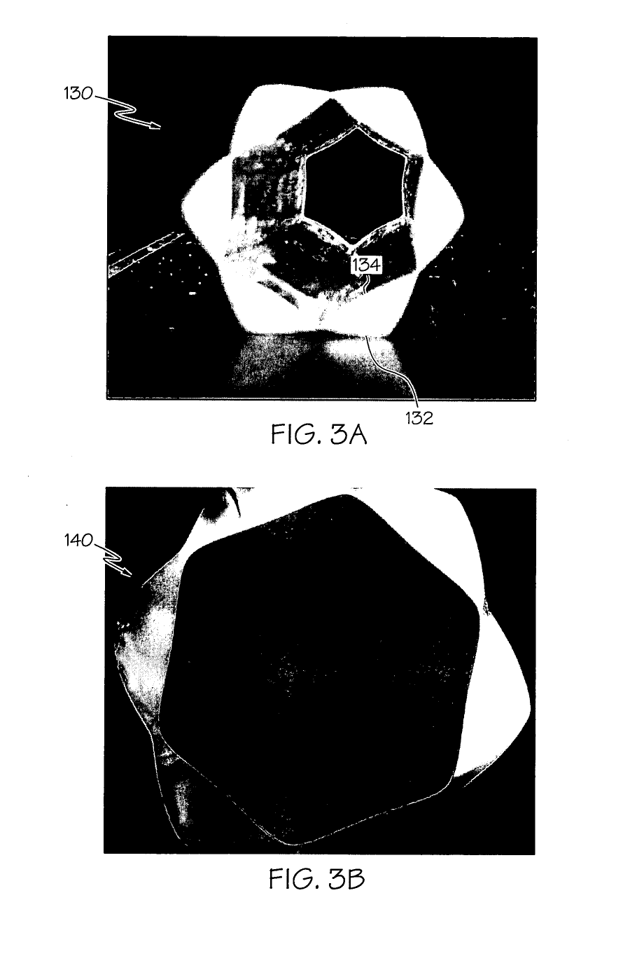

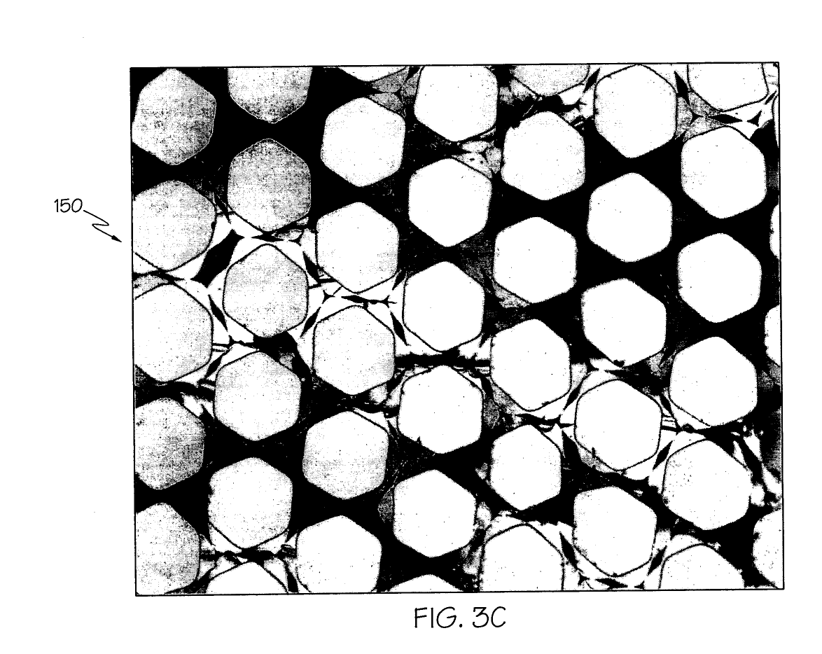

Particularly, through the use of glasses described and contemplated herein, glass tubes can be extruded having any shape (both with respect to outer perimeter/diameter and hole configuration) believed to improve the manufacture of photonic crystal fibers, whereas conventional processes were limited to the manufacture and stacking of circular glass capillaries. For example, referring to FIGS. 3A-3C, images of a glass tube 130 manufactured in accordance with exemplary embodiments of the invention are illustrated. Referring to FIG. 3A, the glass tube 130 comprises a hexagonal outer cross-section/perimeter/diameter 132 and a single hexagonal hole 134. The glass tube 130 may then be redrawn into a cane 140 (see FIG. 3B) and arranged into a stack 150 (see FIG. 3C) by the methods more fully described below. Such exemplary embodiments illustrate the flexibility in manufacturing a variety of geometrically unique tubes for use with the invention thereby leading to advantages in both manufacturability and fiber characteristics.

Referring again to FIGS. 1 and 2A-2C, in one embodiment, the process can start with extrusion of hot glass into the die 20. Prior to extrusion, the glass material can be melted at a temperature of around 1500° C. The glass is cooled at room temperature and then reheated to around 700° C.-900° C. so that it can be extruded. The hot glass is pressed through the die 20 using about 200 to 3000 pounds across the 4″ diameter boule (16 to 210 psi). The extruded tube 30 (top view shown schematically) takes the shape of the corresponding die 20.

Depending on the glass material used, the tube 30 may undergo additional processing at this or a later stage. For example, when using the forgoing precursor glass, the glass may be heat treated after extrusion. Heat treatment of the precursor glass may be conducted at around 580° C. During heat treatment, a phase separation occurs in the glass between the boro-alkali group (very rich in alkali and boric oxide) and the silica-oxygen group (very rich in silica). The heat treated glass material can then undergo a leaching step wherein the alkali borate is removed. The leaching step can be conducted in multiple stages using HNO₃ (i.e. for a 1 mm thick sample is done over a 45 hour period and a 6 mm thick large piece for up to 30 days). The glass structure may then be consolidated at 1225° C. for at least 30 minutes after leaching 60 to collapse the porosity into more of a solid body (e.g., a glass structure formed of densified glass).

It has been discovered that the heat processing (e.g., processing involved with extrusion) described herein does not interfere with phase separation of the foregoing glass. Accordingly, many methods of treating glass precursors of the invention can be realized. For example, rather than extruding and then heat treating, in another embodiment, the glass precursor may first be heat treated and subsequently extruded. It is believed that the subsequent extrusion of a heat treated the glass precursors described herein will not interfere with phase separation. Similarly, in yet another embodiment, the glass precursor may be heat treated to commence phase separation during the extrusion process, thereby combining the two steps.

These steps applied to the foregoing glass precursors (e.g., precursors of R₂O—B₂O₃—SiO₂) result in a glass structure with an interconnected phase separated network of around 1-6 nm size. As a result of the foregoing processes, the softening temperature increases from around 670° C. (glass precursor) to 1500° C. (glass substrate). In addition, the glass structure at this stage is porous (28-30% by volume), with pores ranging in size from about 1 nm to about 12 nm, and an average pore size of about 5 nm-6 nm. In addition, the glass structure comprises at least 90% to about 96% silica by weight (it is 96% silica because 4% residual boron usually remains in the glass structure after leaching). Such a glass structure has a high UV transparency, low thermal expansion and a high softening temperature. For example, such glasses, when consolidated, have a transmittance in the range of about 80%/mm to about 100%/mm at about 230 nm to about 350 nm. Of course, as previously discussed, processing may or may not include any number of steps depending on the silica glass utilized.

Referring to FIGS. 2A-2C, after formation and potential processing, the tube 30 can be redrawn to a cane 40 (e.g., drawdown ratio between 2:1 and 100:1). In one embodiment, the tube 30 may comprise about a three inch diameter and about four feet in length; however, many diameters and lengths are contemplated and can depend on the drawdown ratio for the desired cane 40. For example, canes are typically drawn down to between 1 mm to 20 mm. The more channels present in the tube structure may have an influence on how small of a cane should be redrawn. Of course, the larger the cane, the less cane required to make the stack (described later herein).

Still referring to FIGS. 2A-2C, once the canes 40 are redrawn and cut, the canes may be arranged in an array or stack 50 which will then be placed in an outer clad tube 60 to form a preform build 62. As illustrated, the stack 50 is arranged with fifty-four canes thereby producing a 1996-hole array (54 canes×37 channels per cane). To achieve the same number of channels, conventional techniques would require stacking at least three to six times the number of capillaries, and in some applications, 1996 capillaries. The ability to manufacture numerous in larger structures reduces the total number of canes needed to build and stack and therefore reduces inconsistencies in the preform, and ultimately, the fiber as discussed herein. In addition, because less process time is required to position larger tubes in a stack, efficiency is increased.

Also, because the hexagonal (non-circular) shape of each cane fittingly corresponds to adjacent canes, the canes are able to be stacked and formed together without excessive voids between the canes: The spatial periodicity of the channels in the stack 50 is essentially the same as in individual canes. Also, an important factor in making a fiber preform is consistency and straightness throughout the length of the preform. The processes described herein enable a concise arrangement of the tubes into a stack and within the clad tube, in contrast to the conventional process of stacking which often results in misalignment and gaps. Using larger, robust canes that are shaped to fit together further reduces the chance for misalignment. As a result, fiber preforms manufactured with processes described herein are more consistently aligned and straight throughout the length of the fiber preform. The concise arrangement of tubes described herein eliminates the need to check every cane and lengths of fiber to make sure the correct geometry is present in the hole array, thereby increasing efficiency of the process.

In addition, arrays formed with processes described herein facilitate the ability to draw a fiber with a controllable air fill fraction and smaller pitch between holes. Particularly, because numerous channels can be positioned at any location (and controllably sized) within a cane through extrusion, and voids between the canes are minimized through the fitting correspondence between the canes, an air fill fraction and smaller pitch in a photonic crystal fiber can be realized and manufactured accordingly. The ability to control and/or predict a desirable air fill fraction and small pitch can also dramatically reduce the amount of etching generally required by conventional processes.

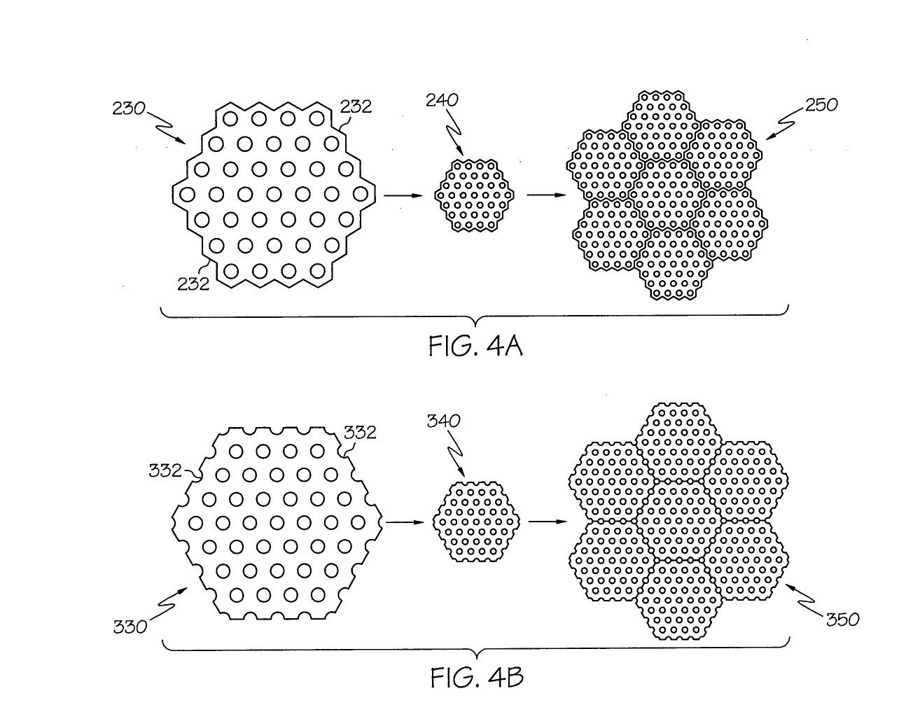

Referring to FIGS. 4A-4B, alternate embodiments of a tube, redrawn cane and stack are illustrated. For example, referring to FIG. 4A, tube 230 has been extruded by processes described herein so as to have a serrated perimeter 232. Although tube 230 of FIG. 4A comprises a serrated perimeter, the entire cross-section/perimeter/outer diameter can still be considered hexagonal in shape because a tracing of the outermost points of the perimeter would yield a hexagon. When a tube 230 such as that illustrated in FIG. 4A is redrawn 240 and stacked 250 the serrated ends of the tubes fittingly correspond with one another similar to a puzzle. In designing a tube 230 in such a fashion, the surface area between each tube (and ultimately the entire stack) can be greatly reduced. Similarly, FIG. 4B illustrates yet another embodiment of a tube 330 extruded by processes described herein so as to have a plurality of semi-circles 332 around its perimeter. Again, the entire perimeter or outer diameter can still be considered hexagonal in shape because a tracing of the outermost points of the perimeter would yield a hexagon. When the tube 330 in FIG. 4B is redrawn 340 and stacked 350 the semi-circles meet to form additional channels between the canes and reduce surface area. As illustrated in FIGS. 2-4, many embodiments of tubes and stacks (and ultimately photonic crystal fibers) can be manufactured through the processes described herein.

Referring again to FIGS. 2A-2C, the stack 50 is formed with a center channel 56 or void. While other stack embodiments may be without a center channel 56 or other intentional hole or center channel (e.g. stacks 150, 250 and 350 for FIGS. 3A-3C and 4A-4B), the center channel in FIGS. 2A-2C creates an intentional defect for the propagation of light. It will be understood that as a result of the flexibility in the extrusion of tubes, holes or defects may be intentionally created at any position within a tube 30 or within the stack 50 (through elimination of tubes as illustrated in FIGS. 2A-2C). Moreover, as illustrated in FIGS. 2A-2C, and as described above, center channels 56 can be designed with any geometric shape, which is believed to enhance performance, especially with respect to fibers with desired bandgaps.

If desired, prior to insertion of the stack 50 into the clad tube 60, the canes 40 of the stack may be fused together (in contrast to placing the loose tubes in the clad tube which will later fuse during redraw of the build). In such processes, the canes can be stacked into an array using a refractory jig to maintain the alignment of the canes. The jig can be two square outer and hexagonal inner pieces with a slight gap between the edges to place a slight pressure on the cane. This jig and canes can be placed into a furnace and heated to a temperature that allows the cane to fuse together but not distort the cane geometry. If desired, pressure can be applied to the cane by placing weight on top of the jig and or widening the gap between the two jig pieces.

As previously discussed with respect to FIGS. 2A-2C, once the canes are redrawn and cut, the canes may be arranged in a microstructure array or stack which will then be placed in an outer clad tube to form a preform build. In one embodiment, the canes occupy at least 90% of the volume of the sleeve or tube (e.g., the volume of the free space directly within the sleeve such as defined by the internal surface of the sleeve and cross-sections perpendicular to the center axis of the sleeve at both ends of the sleeve). Also, in one embodiment, the canes can be stacked such that any empty space between all the canes, excluding the empty central channel, is at most 10% of the total volume of the stack. The preform may then be redrawn 70 into a second cane 80 and sheathed with another tube 80 for drawing into fiber. If desired, the preform build can be directly drawn into the photonic crystal fiber. As a result of the processes described herein, use of larger canes in creating the fiber perform allow more fiber to be drawn from the preform. This ability increases fiber yields.

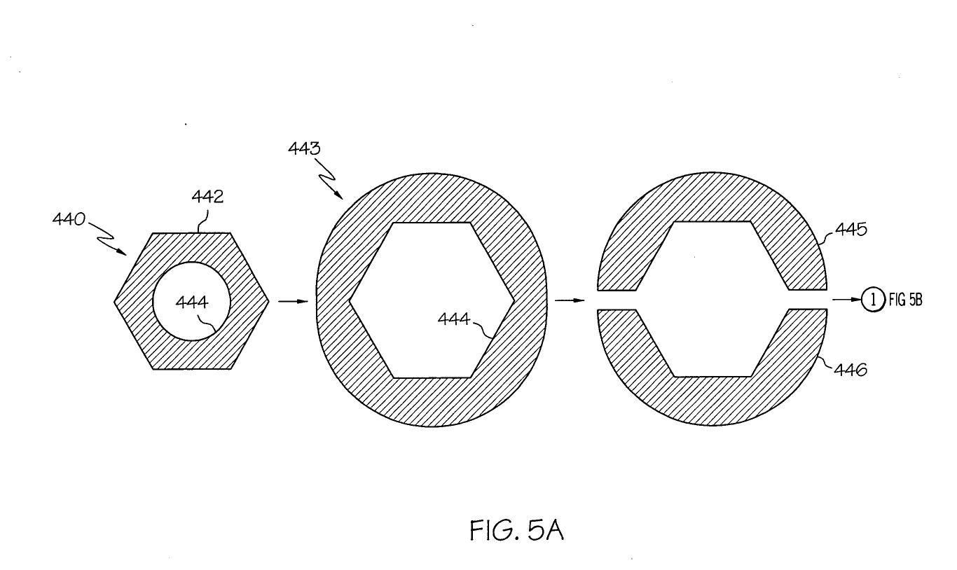

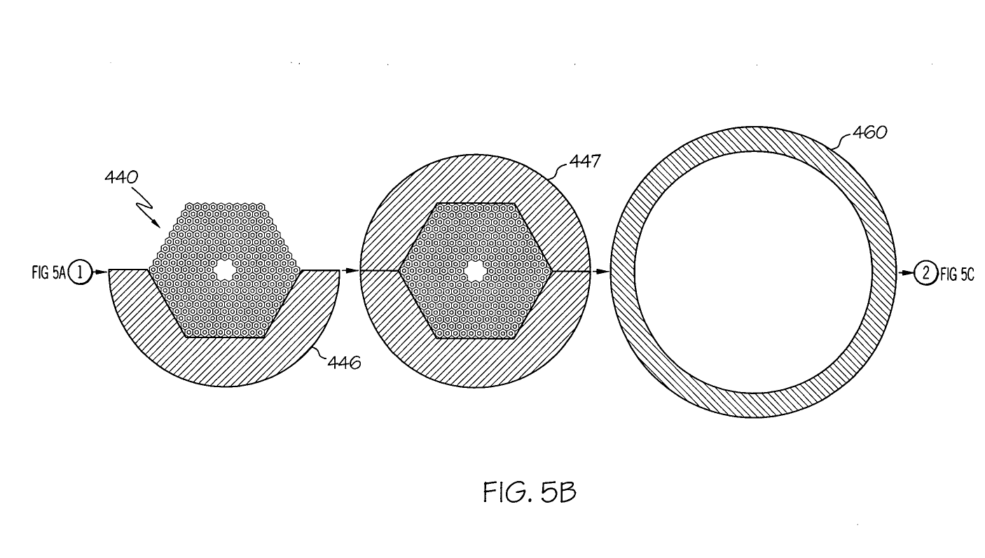

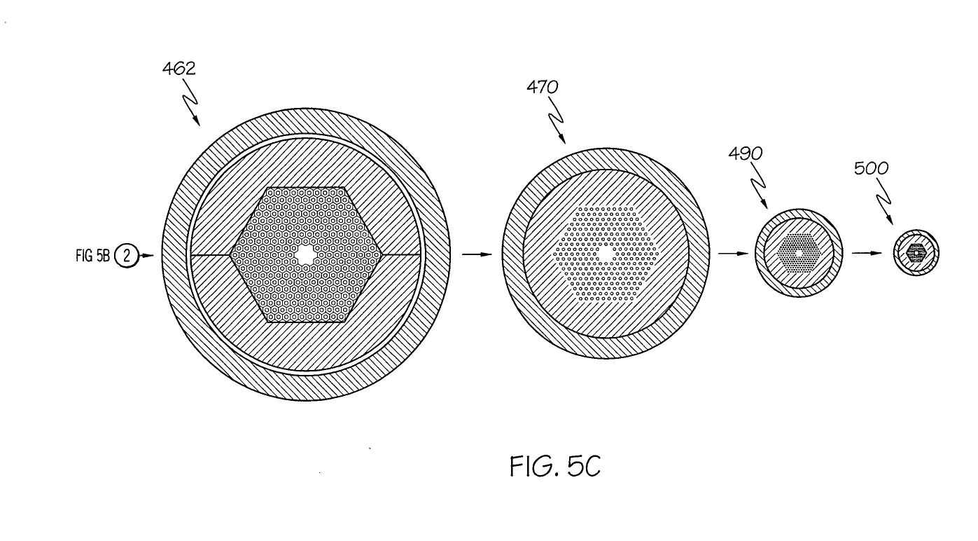

Referring to FIGS. 5A-5C, an alternative embodiment wherein the stack is placed in a glass tube prior to the clad tube is illustrated. In such a process, a tube can be extruded and redrawn as previously described to a cane 440 (note that the cane 440 illustrated in FIGS. 5 A-5C includes a hexagonal outer perimeter with one hole). A cover tube 443 may then be extruded with an inner diameter 444 configured to receive the desired number of shaped canes 440. The cover tube can be comprised of a glass material similar to the stack 50, or any other material. The cover tube 443 may then be cut into first and second portions 445 and 446 and undergo polishing steps. The canes 440 may be stacked into the cover tube 446. Because of the shape of the canes 440 and the inner diameter 444 of the cover tube 443, the canes 440 can be precisely into the cover tube 446. Once the canes are stacked, the first portion 445 can be joined to the second portion 446 to form a joined cover tube 447 and then placed in a clad tube 460. This structure may be redrawn to a cane 470, formed into a fiber preform 490 and then drawn into a photonic crystal fiber 500.

It is a matter of course that the photonic crystal fibers and the methods for manufacturing the same according to the invention are not limited to the embodiments described above. Many alternatives, modifications and variations will be apparent to those skilled in the art of the above teaching. For example, the glass materials in accordance with the invention may comprise a number of glasses and precursors useful for manufacturing a number of structures, and a variety of extruded tubes may be used to build the fiber preform. Accordingly, while some of the alternative embodiments have been discussed specifically, other embodiments will be apparent or relatively easily developed by those of ordinary skill in the art.

What is claimed is:

1. A method for manufacturing a photonic crystal fiber comprising:
hot-forming a glass material into a glass tube having a non-circular outer cross-section;
drawing the glass tube to obtain a plurality of canes;
stacking the canes to create a preform build; and
drawing the preform build to obtain a photonic crystal fiber.

2. The method of claim 1, wherein the drawing the preform build comprises drawing the preform build into a fiber perform and drawing the fiber preform to obtain a photonic crystal fiber.

3. The method of claim 1, wherein the hot-forming comprises extruding the glass material through a die.

4. The method of claim 1, wherein the glass material has a composition, expressed in terms of weight percentages on an oxide basis, consisting essentially of: 55%-75% SiO₂, 5%-10% Na₂O, 20%-35% B₂O₃ and 0%-5% Al₂O₃.

5. The method of claim 1, wherein the glass tube comprises a plurality of channels extending along the axis of the tube.

6. The method of claim 5, wherein the glass tube comprises at least nineteen channels extending along an axis of the tube essentially parallel to each other.

7. The method of claim 1, wherein the stacking canes to create a preform build further comprises aligning the canes to create a preform build containing an empty central channel in proximity to the center of the preform build.

8. The method of claim 7, wherein the empty central channel is non-circular.

9. The method of claim 1, further comprising heat treating the glass material to obtain phase separation in the glass material.

10. The method of claim 9, further comprising leaching the glass material to yield a porous glass structure comprising at least 90% by weight of silica.

11. The method of claim 10, further comprising consolidating the porous glass structure to obtain a glass structure formed of densified glass.

12. The method of claim 11, wherein the leaching and consolidating are implemented before stacking.

13. The method of claim 1, wherein the hot-forming the glass material into glass tube having a non-circular outer cross-section comprises extruding the glass material into a hexagonal tube.

14. A method for manufacturing a photonic crystal fiber comprising:
extruding a precursor glass material having a composition, expressed in terms of weight percentages on an oxide basis, consisting essentially of: 55%-75% SiO₂, 5%-10% Na₂O, 20%-35% B₂O₃ and 0%-5% Al₂O₃, to obtain a glass tube having a plurality of channels extending along the axis of the tube;
leaching the glass tube to obtain a porous glass tube comprising at least 90% by weight of silica;
heating the porous glass tube such that the pores in the glass structure collapse to form densified glass to obtain a densified glass tube;
drawing the densified glass tube to obtain a plurality of glass canes;
forming a stack of the glass canes, each of the glass canes in direct contact with an adjacent glass cane in the stack; and
drawing the stack to obtain a photonic crystal fiber.

15. The method of claim 14, wherein the tube comprises at least nineteen channels extending along an axis of the tube.

16. The method of claim 14, wherein the forming the stack further comprises forming the stack to create an empty central channel in proximity to the center of the preform build.

17. The method of claim 16, wherein the canes are stacked such that an empty space between all the canes, excluding the empty central channel, is at most 10% of the total volume of the stack, excluding the central empty channel and the channels in the canes.

18. A photonic crystal fiber preform build comprising a plurality of extruded non-circular glass canes, each of the extruded non-circular glass canes comprising at least one channel extending along the axis of the cane.

19. The photonic crystal fiber preform build of claim 18, wherein the spatial periodicity of the channels within the plurality of canes is essentially the same and in the stack, the overall periodicity of the channels is essentially the same as in individual canes.

20. The photonic crystal fiber preform build of claim 18, wherein the plurality of glass canes are placed inside a glass tube sleeve, and the glass canes occupy at least 90% of the volume of the sleeve.
